(19) United States
(12) Patent Application Publication
(10) Pub. No.: US 2024/0030572 A1
(43) Pub. Date: Jan. 25, 2024

(54) ATTACHMENT FOR COLLECTING LIQUID AND VAPORIZED ELECTROLYTE FROM A BATTERY RELIEF VENT

(71) Applicant: The United States of America, as represented by the Secretary of the Navy, Crane, IN (US)

(72) Inventors: Christopher Hammond, Bloomington, IN (US); Lawrence S. Pate, Solsberry, IN (US)

(73) Assignee: The United States of America, as represented by the Secretary of the Navy, Arlington, VA (US)

(21) Appl. No.: 18/215,879

(22) Filed: Jun. 29, 2023

Related U.S. Application Data
(60) Provisional application No. 63/357,259, filed on Jun. 30, 2022.

(51) Int. Cl. H01M 50/691

(52) U.S. Cl. CPC H01M 50/691

(57) ABSTRACT

A containment apparatus for collecting electrolyte from a battery relief vent is provided. The containment apparatus includes a body comprising a reservoir, a relief vent aperture, an internal baffle, and an upper vent aperture; a push-on connection that attaches the relief vent aperture to the battery relief vent; and a viewing window on an external side of the body. The containment apparatus attaches to a pressure relief vent on a battery to capture droplets of electrolyte that are released from the battery relief vent. Liquid electrolytes travel through the relief vent aperture and into the reservoir, and vaporized electrolyte condenses on the baffle and falls into the reservoir as droplets or travels past the baffle and is directed through the upper vent aperture via the walls. The device prevents electrolytes from accumulating on the outside of the battery and associated hardware within the vicinity of the battery.

### Cross-Reference to Related Applications

The present application claims priority to U.S. Provisional Patent Application Ser. No. 63/357,259, filed Jun. 30, 2022, entitled “VALVE REGULATED BATTERY VENT ACID CATCH SYSTEM (VACS),” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 210088U502) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD OF THE INVENTION

The field of invention relates generally to batteries. More particularly, it pertains to a containment apparatus for collecting liquid and vaporized electrolyte from a battery relief vent.

### BACKGROUND

Valve regulated (sealed) batteries have been around for many years. During certain charge and/or discharge events, valve regulated batteries are designed to open pressure relief vents and relieve pressure to prevent cell damage. The intent of valve regulated battery design is such that venting does not occur during typical operations, however, uses have expanded and become more demanding because of technology advancements. Depending on the orientation, location, and environment, venting may cause no issues, but in newly evolving applications and environments, batteries cannot simply be allowed to vent without precautions taken.

Battery manufacturers have not concerned themselves with looking at what happens to vented electrolyte when batteries vent. Old methods for capturing and containing vented electrolyte on valve regulated batteries often included simply waiting until after venting and subsequent damage occurred and then clean and/or replace equipment as required. When electrolyte is allowed to accumulate outside of the battery, it can cause excessive corrosion along with creating un-wanted electrical grounding paths to adjacent trays or equipment. Accumulated electrolyte can cause permanent damage to surrounding equipment and may require extensive repeated cleaning and possibly replacement of equipment from corrosion or electrical grounding damage.

### SUMMARY OF THE INVENTION

The present invention relates to a containment apparatus for collecting liquid and vaporized electrolyte from a battery relief vent. The device includes a body comprising a reservoir, a relief vent aperture, an internal baffle, and an upper vent aperture; a push-on connection comprising a rubber O-ring and a fixed stop for attaching the relief vent aperture to the battery relief vent; and a viewing window on an external side of the body. The device attaches to a pressure relief vent located on valve regulated batteries to capture droplets of electrolyte without impeding the function of the vent. The containment apparatus attaches to a pressure relief vent on a battery to capture droplets of electrolyte that are released from the battery relief vent. Liquid electrolytes travel through the relief vent aperture and into the reservoir, and vaporized electrolyte condenses on the baffle and falls into the reservoir as droplets or travels past the baffle and is directed through the upper vent aperture via the walls. The containment apparatus prevents electrolytes from accumulating on the outside of the battery and associated hardware within the vicinity of the battery.

In an illustrative embodiment, the containment apparatus captures liquid and vaporized electrolyte and eliminates the damage and extensive cleaning that is otherwise required.

In an illustrative embodiment, the containment apparatus allows expelled gases (such as Oxygen and Hydrogen) to escape without the electrolyte.

In an illustrative embodiment, the containment apparatus allows the user to also see electrolyte vapor, which forms as droplets on the inside of the clear window. Normally, this vaporized electrolyte is not visible and not found until corrosion and subsequent cleaning is required. As can be appreciated, early detection allows users to identify potential defective vents more easily, which is not otherwise possible.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 shows a perspective view of the containment apparatus.

FIG. 2 shows a perspective view of the containment apparatus.

FIG. 3 shows a view of the window.

FIG. 4 shows a side view of the containment apparatus.

FIG. 5 shows a view of the containment apparatus installed on a valve regulated battery.

FIG. 6 shows a close-up view of the integrated 0-ring seal and fixed stop.

FIG. 7 shows a close-up view of the integrated 0-ring seal and fixed stop.

FIG. 8 shows a close-up view of the containment apparatus installed on a valve regulated battery.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

Generally, provided is a containment apparatus for collecting liquid and vaporized electrolyte from a battery relief vent comprising: a body comprising a reservoir, a relief vent aperture, an internal baffle, and an upper vent aperture; a push-on connection comprising a rubber 0-ring and a fixed stop for attaching the relief vent aperture to the battery relief vent; and a viewing window on an external side of the body. In an illustrative embodiment, the internal baffle comprises a V-shaped extension positioned above the push-on connection and a channel that direct the vaporized electrolyte to the upper vent aperture. In an illustrative embodiment, the viewing window comprises an installation direction indicator. In an illustrative embodiment, the liquid and vaporized electrolyte released from the battery relief vent deflects and condense on the internal baffle and window in order to safely capture it within the hanging chamber.

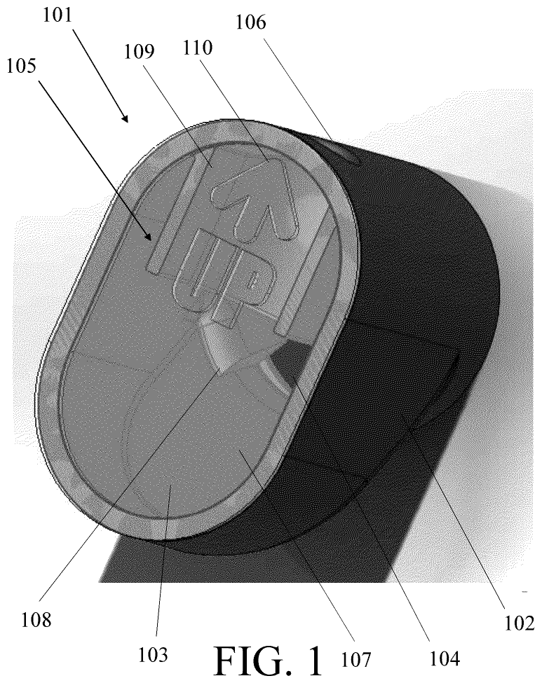

FIG. 1 shows a perspective view of the containment apparatus 101. In an illustrative embodiment, the containment apparatus comprises a body 102 comprising a reservoir 103, a relief vent aperture 104, an internal baffle 105, and an upper vent aperture 106; a push-on connection comprising an 0-ring and a fixed stop (not show) for attaching the relief vent aperture to the battery relief vent (not shown); and a viewing window 107 on an external side of the body 102. In an illustrative embodiment, the internal baffle 105 comprises a V-shaped extension 108 positioned above the push-on connection and a channel 109 that direct the vaporized electrolyte to the upper vent aperture 106. In an illustrative embodiment, the viewing window 107 comprises an installation direction indicator 110.

In an illustrative embodiment, the containment apparatus 101 attaches to a battery vent via a push-on connection to the top of the battery relief vent via the relief vent aperture 104. The fixed stop 201 allows a positive positioning and prevent over-insertion on the relief vent. In an illustrative embodiment, a rubber 0-ring (shown below) allows a pinch compression attachment method.

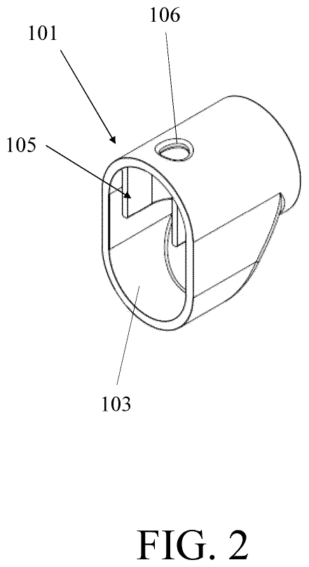

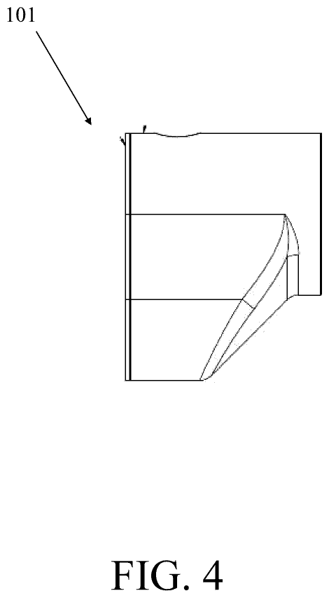

FIG. 2 shows a perspective view and FIG. 4 shoes a side view of the containment apparatus 101. In an illustrative embodiment, any liquid and/or vaporized electrolyte is deflected and/or condensed on the internal baffle 105 and is deposited in the reservoir 103. As can be appreciated, the battery relief vents have a natural inverse draft angle from the injection molding process, which the containment apparatus 101 uses to advantage. In an illustrative embodiment, the containment apparatus 101 comprises an upper vent aperture 106, which allows the pressurized gases from the battery to escape, while containing the electrolyte from spraying out utilizing the internal baffle 105. In an illustrative embodiment, the internal baffle 105 comprises a channel. In an illustrative embodiment, the internal baffle 105 comprises a U-shaped channel that directs gases towards the upper vent aperture 106.

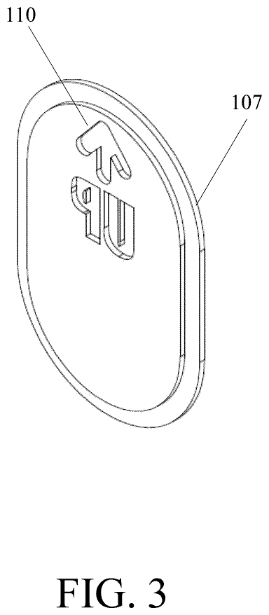

FIG. 3 shows a view of the window 107. In an illustrative embodiment, the viewing window 107 forms an external side of the body 102 (as best illustrated in FIG. 1). The viewing window 107 allows a user to easily see any captured electrolyte and electrolyte vapor, which forms as droplets on the inside of the viewing window 107. As can be appreciated, without the containment apparatus 101 installed on a battery vent, the vaporized electrolyte is not visible and is not found until corrosion and subsequent cleaning is required. The inventive containment apparatus 101 also affords the benefit of allowing a user to identify potential defective vents more easily, which is difficult or impossible without the use of the device.

In an illustrative embodiment, the viewing window 107 further includes an installation direction indicator 110. As can be appreciated, it is desirable to install the containment apparatus in the proper orientation, so as to ensure the upper vent aperture is facing up and the reservoir is facing down. The permits the liquids to remain in the reservoir and gases to escape through the upper vent aperture. If installed incorrectly, the liquid can drip through the upper vent aperture, thereby defeating the purpose of installing the containment apparatus on a battery vent.

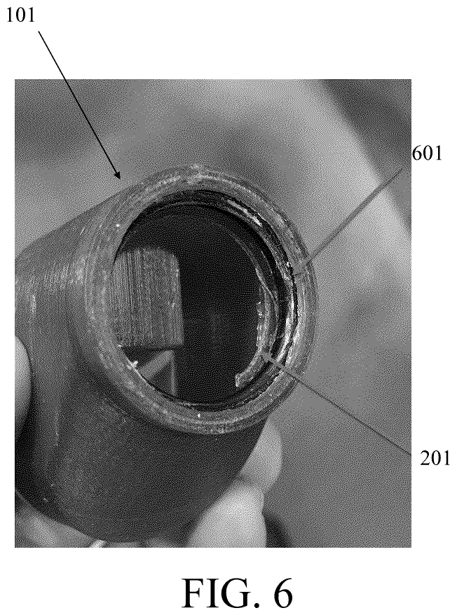

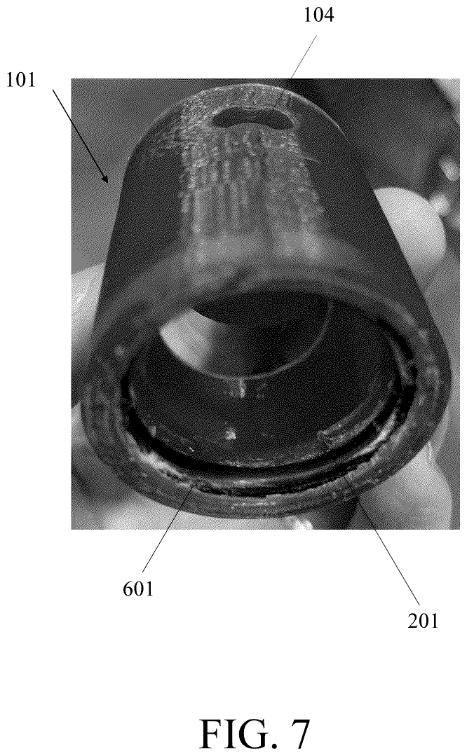

FIGS. 6-7 show close-up views of the integrated 0-ring seal 601 and fixed stop 201. The 0-ring seal 601 and the containment apparatus 101 attaches to a battery vent via a push-on connection to the top of the battery relief vent via the relief vent aperture 104. The fixed stop 201 allows a positive positioning and prevent over-insertion on the relief vent. In an illustrative embodiment, the 0-ring 601 ensures a secure connection and prevents leakage of fluid.

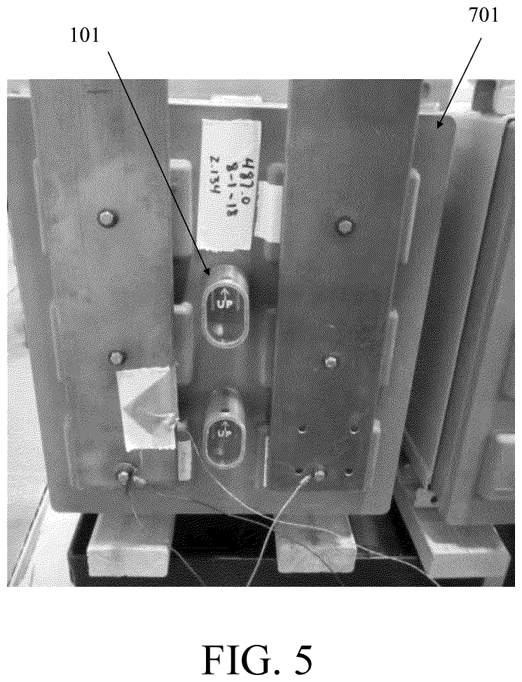

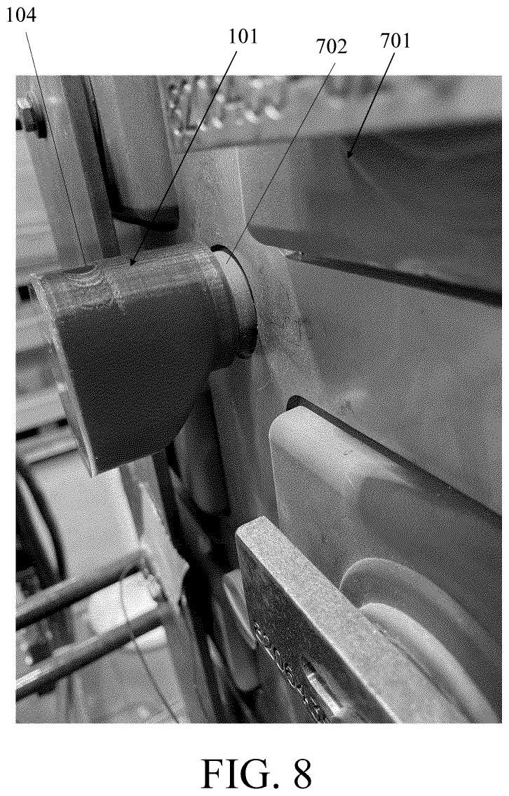

FIGS. 5 and 8 show views of the containment apparatus 101 installed on a valve regulated battery 701. In an illustrative embodiment, the containment apparatus 101 can be installed and used on a battery 701 while battery cells have pressure relief vents 702 oriented in a horizontal position. In an illustrative embodiment, the containment apparatus 101 can be configured to allow use in the vertical vent positions. The containment apparatus 101 attaches to a pressure relief vent located on valve regulated batteries to capture droplets of electrolyte without impeding the function of the pressure relief vents 702. In operation, liquid electrolytes are released from the pressure relief vent 702 and travel through the relief vent aperture 104 and into the reservoir 103 (best shown in FIGS. 1A-B). Vaporized electrolyte either condenses on the V-shaped extension 106 and falls into the reservoir 103 as droplets or travels past the V-shaped extension 106 and is directed through the upper vent aperture 106 via the baffle 105. The containment apparatus 101 prevents electrolytes from accumulating on the outside of the battery 701 and associated hardware within the vicinity of the battery.

In an illustrative embodiment, the containment apparatus 101 can be utilized on submarine valve regulated lead acid batteries. In an illustrative embodiment, the invention can be used in a variety of applications that utilize valve regulated batteries or cells. Other applications include uninterruptible power supply (UPS) systems or alternative energy storage systems. In an illustrative embodiment, modifications to the vent interface design ending on the vent design enable the containment apparatus 101 to be used in numerous applications and battery chemistries.

Although the invention has been described in detail with reference to certain preferred embodiments, variations and modifications exist within the spirit and scope of the invention as described and defined in the following claims.

1. A containment apparatus for collecting liquid and vaporized electrolyte from a battery relief vent comprising:
a body comprising a reservoir, a relief vent aperture, an internal baffle, and an upper vent aperture;
a push-on connection that attaches said relief vent aperture to said battery relief vent; and
a viewing window on an external side of said body.

2. The containment apparatus of claim 1, wherein said liquid and vaporized electrolyte released from said battery relief vent deflects and condense on said internal baffle and window in order to capture said electrolyte within said reservoir.

3. The containment apparatus of claim 1, wherein said push-on connection further comprises a rubber 0-ring and a fixed stop.

4. The containment apparatus of claim 1, wherein said baffle comprises a V-shaped extension positioned above said push-on connection and a channel that direct said vaporized electrolyte to said upper vent aperture;

5. The containment apparatus of claim 1, wherein said viewing window comprises an installation direction indicator.

6. A containment apparatus for collecting liquid and vaporized electrolyte from a battery relief vent comprising:
a body comprising a reservoir, a relief vent aperture, an internal baffle, and an upper vent aperture;
a push-on connection comprising a rubber 0-ring and a fixed stop for attaching said relief vent aperture to said battery relief vent; and
a viewing window on an external side of said body;
wherein said internal baffle comprises a V-shaped extension positioned above said push-on connection and a channel that direct said vaporized electrolyte to said upper vent aperture;
wherein said viewing window comprises an installation direction indicator;
wherein said liquid and vaporized electrolyte released from said battery relief vent deflects and condense on said internal baffle and window in order to capture said electrolyte within said reservoir.
